(19) United States
(12) Patent Application Publication
(10) Pub. No.: US 2007/0097858 A1
(43) Pub. Date: May 3, 2007

(54) Method and computer system for employing an interconnection fabric providing multiple communication paths

(76) Inventors: Gregg Bernard Lesartre, Fort Collins, CO (US); Michael Joseph Phelps, Cheyenne, WY (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/263,772

(22) Filed: Nov. 1, 2005

(51) Int. Cl. H04J 3/14; H04J 1/16

(52) U.S. Cl. 370/228; 370/244

(57) ABSTRACT

A method for employing an interconnection fabric of a computer system including a first endnode and a second endnode is provided. A first transaction is transferred from the first endnode toward the second endnode over a primary path of the fabric. The first transaction is retransferred from the first endnode toward the second endnode over an alternate path of the fabric after a period of time after transferring the first transaction. An acknowledgement of the first transaction being received by the second endnode over the primary path is transferred to the first endnode after retransferring the first transaction. A second transaction from the first endnode toward the second endnode is transferred solely over the primary path after the acknowledgement is received by the first endnode.

### BACKGROUND OF THE INVENTION

Simple computer systems typically employ one or more static buses to couple together processors, memory, input/output (I/O) systems, and the like. However, more modern, high-performance computer systems often interconnect multiple processors, memory modules, I/O blocks, and so forth by way of multiple, reconfigurable, internal communication paths. For example, in the case of multiprocessing systems employing a single-instruction, multiple-data stream (SIMD) or multiple-instruction, multiple-data stream (MIMD) computer architecture, multiple processors may communicate simultaneously with other portions of the computer system for data storage and retrieval, thus requiring multiple communication paths between the processors and other parts of the system. One distinct advantage of such a system is that these paths typically provide redundancy so that a failure in one of these paths may be circumvented by the use of an alternate path through the system.

FIG. 1 provides a simplified block diagram of one possible computer system 100 employing multiple internal communication paths. A first set of endnodes 102 communicates with a second set of endnodes 104 by way of a set of switches 106. Each port 112 of the endnodes 102, 104 is coupled with a similar port 112 of one of the switches 106 by way of a communication link 108. Together, the switches 106 and the communication links 108 constitute a computer system interconnection “fabric” 101 through which the endnodes 102, 104 communicate with each other. In one particular example, each of the first set of endnodes 102 may be processors, while each of the second set of endnodes 104 may include memory, I/O processors, and the like. In addition, some endnodes 102, 104 may communicate directly with each other without the aid of one of the switches 106 by way of point-to-point links 110.

In the particular example of FIG. 1, each endnode 102, 104 is connected directly to each of the switches 106 so that several alternative communication paths exist between each of the first set of endnodes 102 and each of the second set of endnodes 104. The communication paths existing at any point in time through the interconnection fabric 101 are determined by the state of each of the switches 106. In one specific example, each of the switches 106 is a crossbar switch which connects each of its ports 112 connected with one of the first set of endnodes 102 with one of its ports 112 that is connected with one of the second set of endnodes 104. In alternative computer system configurations, the interconnection fabric may contain two or more levels of switches 106, such that each of the first set of endnodes 102 is connected with one of the second set of endnodes 104 by way of two or more switches 106. In another configuration, each of the first set of endnodes 102 may be coupled directly to each of the second set of endnodes 104 without the use of a switch 106. Innumerable other interconnection fabric configurations also exist.

As can be seen in FIG. 1, the interconnection fabric 101 provides multiple potential communication paths to each of the first and second sets of endnodes 102, 104. The computer system 100 thus possesses the ability to circumvent failures in the system 100 in order to continue operating. More specifically, a failure in one of the endnodes 102, 104, switches 106, communication links 108, or communication ports 112 may be bypassed by way of an alternative path through the fabric 101.

Oftentimes, what appears to be a failure of a communication path of the computer system 100 may actually be caused by a failure of a nearby portion of the computer system 100 that negatively impacts the original path through the interconnection fabric 101. Under these circumstances, such a failure is likely to cause a permanent change from the original path to an alternate path. However, once the failure precipitating the change has been isolated, returning the original path to service would be desirable to eliminate any undesirable effects on system interconnectivity or throughput caused by the change.

### SUMMARY OF THE INVENTION

One embodiment of the present invention provides a method for employing an interconnection fabric of a computer system having a first endnode and a second endnode. A first transaction is transferred from the first endnode toward the second endnode over a primary path of the fabric. The first transaction is retransferred from the first endnode toward the second endnode over an alternate path of the fabric after a period of time after transferring the first transaction. An acknowledgement of the first transaction being received by the second endnode over the primary path is transferred to the first endnode after retransferring the first transaction. A second transaction from the first endnode toward the second endnode is transferred solely over the primary path after the acknowledgement is received by the first endnode.

A further embodiment of the invention provides a computer system having first and second endnodes, and an interconnection fabric coupling the first and second endnodes. The first endnode is configured to transfer a first transaction toward the second endnode over a primary path of the fabric. Also, the first endnode is configured to retransfer the first transaction toward the second endnode over an alternate path of the fabric after a period of time after the transfer of the first transaction. In addition, the first endnode is configured to transfer a second transaction toward the second endnode solely over the primary path after an acknowledgement of the first transaction being received by the second endnode over the primary path is received by the first endnode.

Additional embodiments and advantages of the present invention will be realized by those skilled in the art upon perusal of the following detailed description, taken in conjunction with the accompanying drawings.

### BRIEF DESCRIPTION OF THE DRAWINGS

FIG. 1 is a block diagram of an example of a computer system employing an interconnection fabric from the prior art.

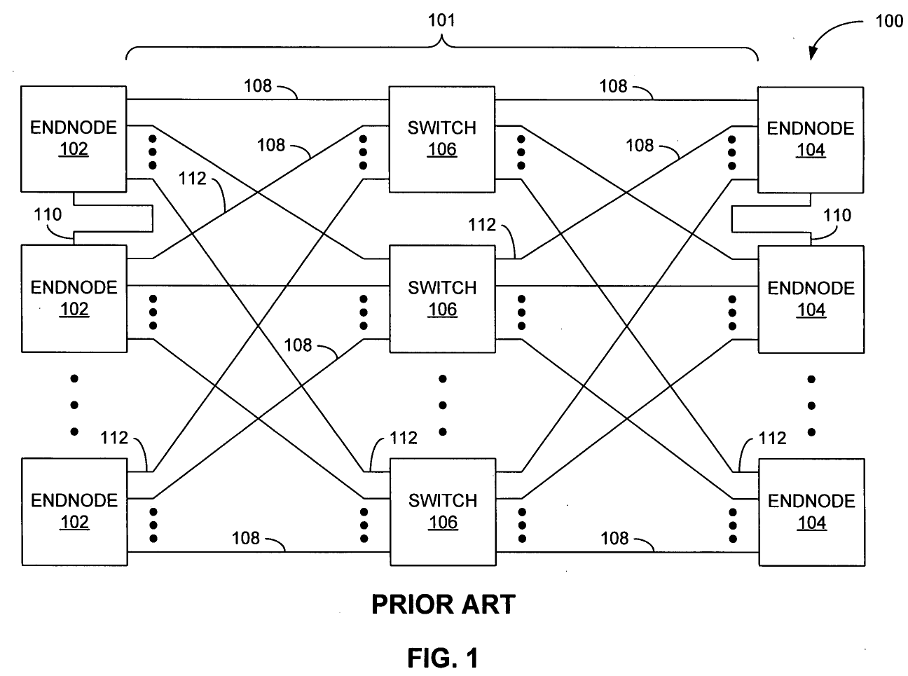

FIG. 2 is flow chart of a method for employing a computer system interconnection fabric according to an embodiment of the invention.

FIG. 3 is a block diagram of a portion of a computer system according to an embodiment of the invention employing an interconnection fabric.

FIG. 4 is a block diagram of an endnode of the computer system of FIG. 3 according to an embodiment of the invention.

FIG. 5 is a flow chart of a method as implemented by a sending endnode of the computer system of FIG. 3 for employing an interconnection fabric according to an embodiment of the invention.

FIG. 6 is a flow chart of a method as implemented by a receiving endnode of the computer system of FIG. 3 for employing an interconnection fabric according to an embodiment of the invention.

FIG. 7 is a flow chart of an example set of communication transactions and acknowledgements between a pair of endnodes of the computer system of FIG. 3 according to an embodiment of the invention.

### DETAILED DESCRIPTION OF THE INVENTION

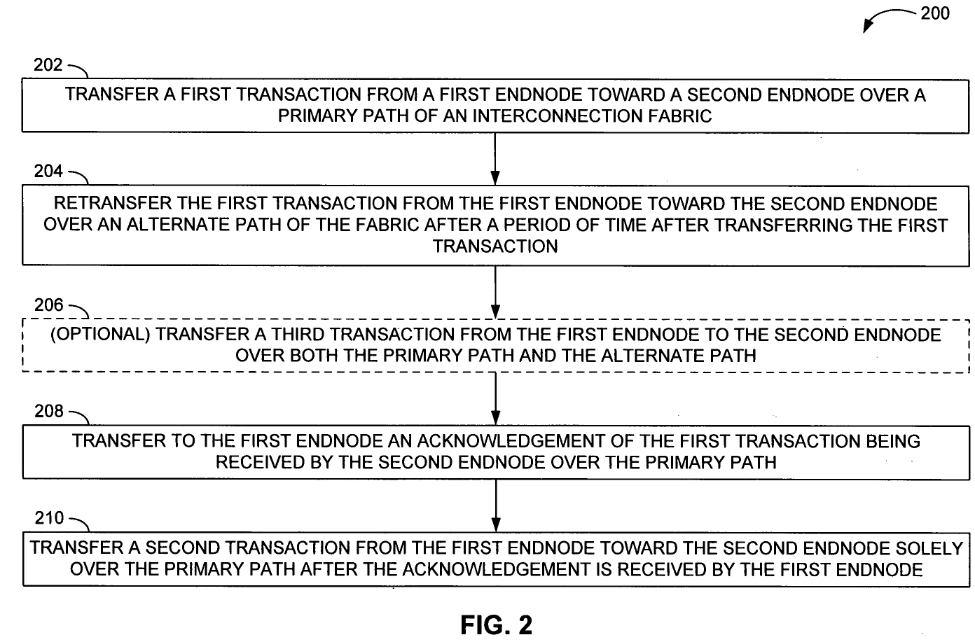

Generally, various embodiments of the present invention provide a method 200 for employing an interconnection fabric of computer system including a first endnode and a second endnode, as shown in FIG. 2. The endnodes may be, for example, processors, storage modules, I/O blocks, and so forth. A first transaction is transferred from the first endnode toward the second endnode over a primary path of the fabric (operation 202). The first transaction is retransferred from the first endnode toward the second endnode over an alternate path of the fabric after a period of time after transferring the first transaction (operation 204). An acknowledgement of the first transaction received by the second endnode over the primary path is transferred to the first endnode after the first transaction has been retransferred (operation 208). A second transaction from the first endnode toward the second endnode is transferred solely over the primary path after the acknowledgement is received by the first endnode (operation 210). Optionally, a third transaction is transferred from the first endnode toward the second endnode over both the primary path and the alternate path after retransferring the first transaction, and before transferring the acknowledgement (operation 206).

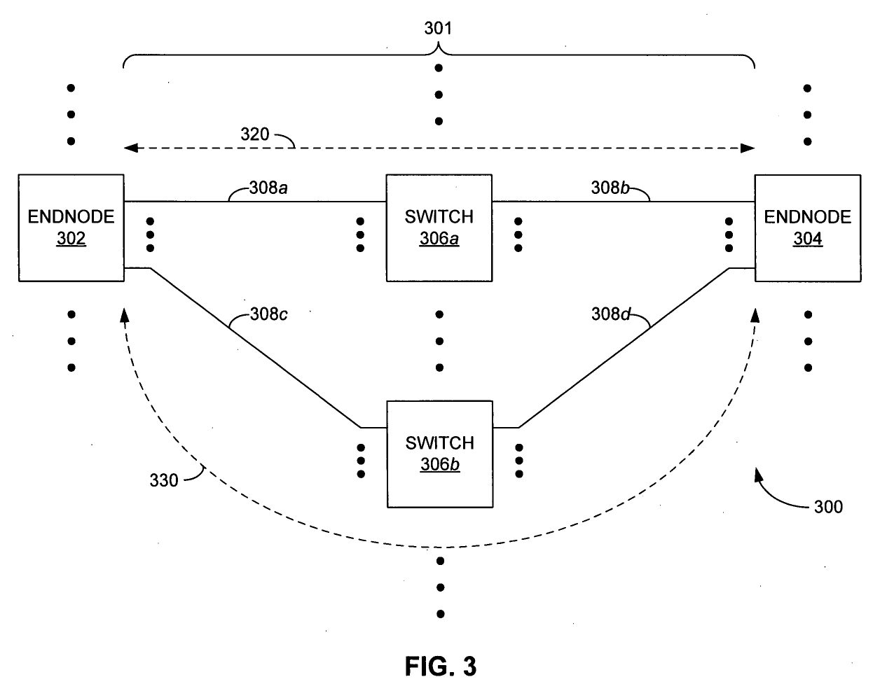

FIG. 3 depicts a portion of one example of a computer system 300 having an interconnection fabric 301. The system 300 employs a method according to a particular embodiment of the invention for using the fabric 301. In this case, a first endnode 302 and a second endnode 304 typically communicate by way of a primary path 320 through a first switch 306a, a first communication link 308a between the first endnode 302 and the first switch 306a, and a second communication link 308b between the second endnode 304 and the first switch 306a. At least one alternate path 330, by way of a second switch 306b, a third communication link 308c, and a fourth communication link 308d, facilitates communication between the first endnode 302 and the second endnode 304 in case the primary path 320 via the first switch 306a fails. Normally, other endnodes, switches and communication links are provided within computer system 300, but are not shown in FIG. 3 to simplify and facilitate explanation of the embodiments of the invention disclosed herein.

The switches 306a, 306b, and the communication links 308a-308d shown in FIG. 3 typically provide bidirectional communication capability between the first and second endnodes 302, 304. In one implementation, the switches 306a, 306b are crossbar switches configured to allow simultaneous connections between a first set of endnodes including the first endnode 302, and a second set of endnodes including the second endnode 304. In alternative embodiments, other types of switches 306 may be employed while remaining within the scope of the invention.

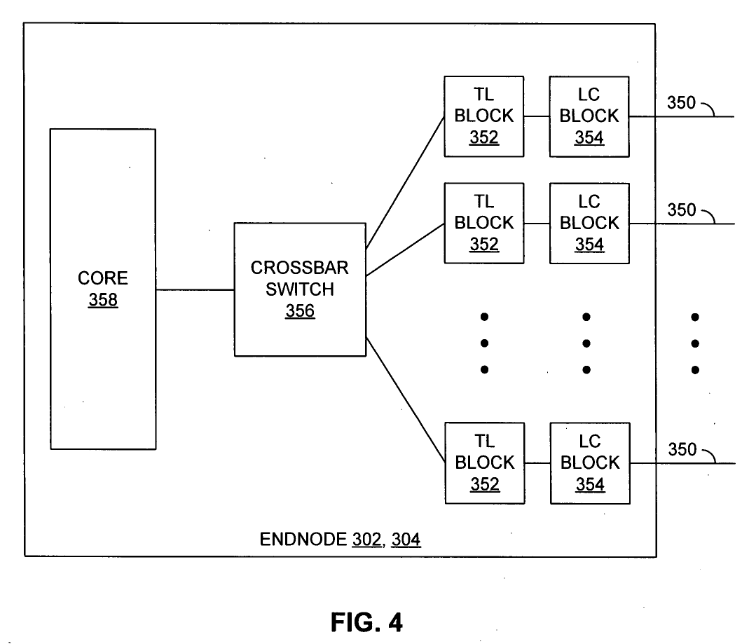

The endnodes 302, 304 may be any functional or operational logic block that performs a computer-related task. For example, the endnodes 302, 304 may include, but are not limited to, processors, memory blocks, or I/O blocks. As shown in greater detail in FIG. 4, each of the endnodes 302, 304 provides one or more ports 350, each of which provide its endnode 302, 304 a connection with a communication link 308a-308d. In addition, each port 350 is normally connected within its endnode 302, 304 to one or more logic blocks configured to handle the sending and receiving of data and control information between the interconnection fabric 301 and other internal circuitry of the endnode 302, 304. In one example, such logic blocks may include a transport layer (TL) block 352 and a link controller (LC) block 354. In one embodiment, the TL block 352 may be configured to package data for transfer over a communication link 308, decode or extract information received over a communication link 308, and so forth. The TL block 352 also determines whether the primary path 320 or the alternate path 330 is employed for communication with another portion of the system 300. The LC block 354, in some embodiments, performs the actual signaling and handshaking of information over a communication link 308. In some embodiments, the LC block 354 may also provide queuing of ingoing and outgoing information over a communication link 308, as well as control traffic over the link 308, depending on other activity within its corresponding endnode 302, 304.

Further, in one implementation, each of the TL blocks 352 within a particular endnode 302, 304 may be interconnected by way of an internal crossbar switch 356 so that data may be sent from or received into the endnode 302, 304 by any of a number of associated ports 350. In one example, the internal crossbar switch 356 is also coupled with endnode core circuitry 358 configured to perform the functions associated with the endnode 302, 304, such as arithmetic or logical data processing, I/O processing, data storage, and the like. However, alternative embodiments of the particular invention, as set forth in greater detail below, may employ an alternative internal arrangement, and thus may not require the use of any of the particular internal blocks of the endnode 302, 304 depicted in FIG. 4.

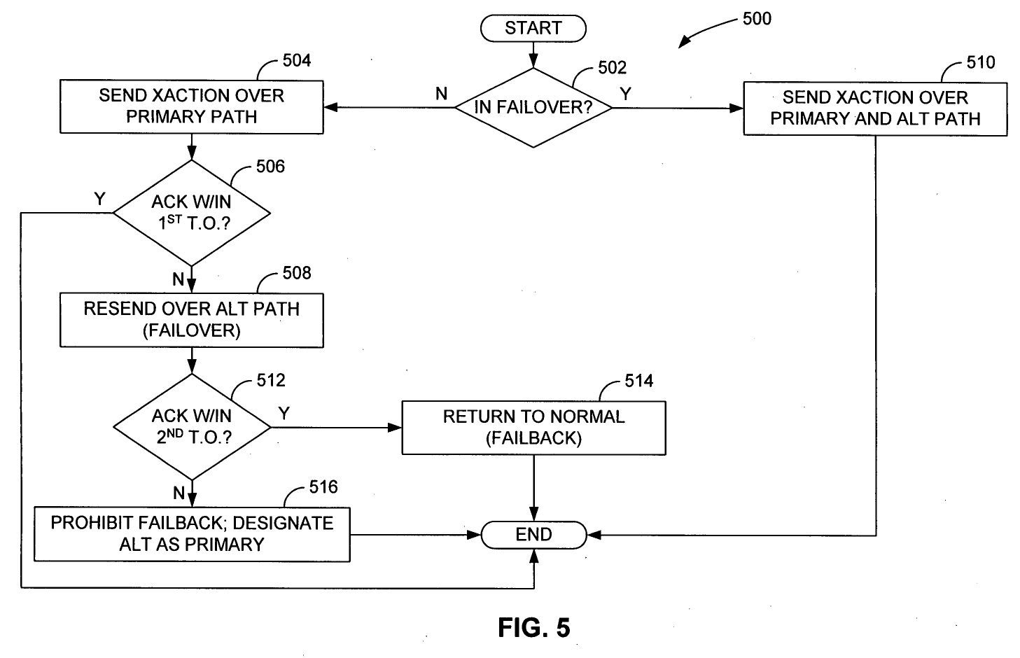

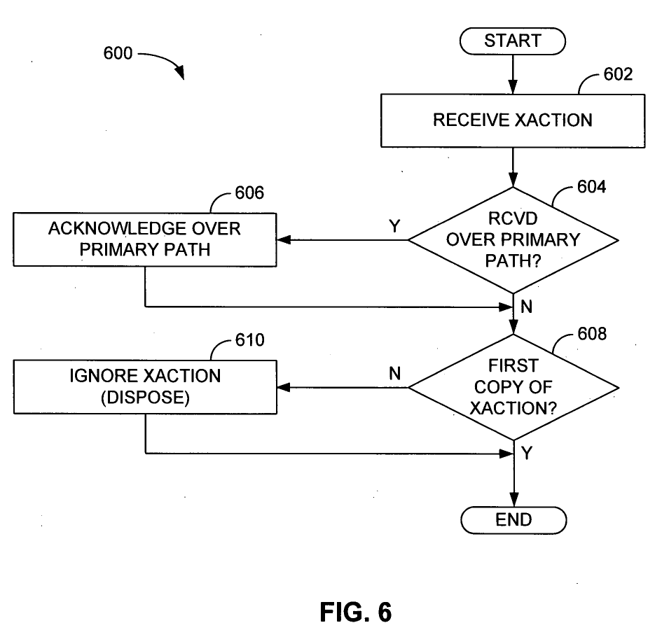

In further reference to FIG. 3, communication from the first endnode 302 (in this case, the “sending endnode”) to the second endnode 304 (the “receiving endnode” in this example) is implemented in one embodiment by way of one or more “transactions,” which typically include control information, plus possibly some amount of data, transferred from the first endnode 302 to the second endnode 304. FIG. 5 is a simplified flow diagram for implementing a method 500 employed by the first endnode 302 according to an embodiment of the invention for transferring a transaction to the second endnode 304. Similarly, FIG. 6 is a flow diagram of a method 600 for the second endnode 304 for receiving a transaction from the first endnode 302 according to an embodiment of the invention.

During normal operation (decision 502), each of the transactions from the first endnode 302 to the second endnode 304 follow the primary path 320 described above (operation 504). Further, for each transaction received by the second endnode 304 (operation 602) over the primary path (decision 604), an “acknowledgement” is returned by the second endnode 304 to the first endnode 302 via the primary path 320 to indicate to the first endnode 302 that the transfer of the transaction was successful (i.e., the transaction was successfully received by the second endnode 304) (operation 606). In one embodiment, each acknowledgement also returns an indication of the transaction with which it is associated. Also, in one implementation, the acknowledgement may not be issued directly from the second endnode 304, but some other portion of the computer system 300.

To determine whether a particular transaction from the first endnode 302 was transferred successfully to the second endnode 304 over the primary path 320, the first endnode 302 normally implements a timer associated with each outstanding transaction sent to the second endnode 304. If the first endnode 302 does not receive an acknowledgement from the second endnode 304 in response to a particular transaction within a time period indicated by the timer (decision 506), the first endnode 302 assumes the transaction was not successfully transferred. As a result of this timeout, the first endnode 302 switches, or “fails over,” from the primary path 320 to the alternate path 330 describe earlier (operation 508). Thus, the first endnode 302 then reissues the transaction to the second endnode 304 by way of the alternate path 330 (also operation 508). In one embodiment, for each additional transaction issued by the first endnode 302 to the second endnode 304 during “failover” (decision 502), the first endnode 302 transfers the transactions over both the primary path 320 and the alternate path 304 (operation 510).

By receiving transactions over the alternate path 330 from the first endnode 302, the second endnode 304 is alerted that the first endnode 302 has failed over to the alternate path 330. For each reissued transaction received over the alternate path 330 (decision 604), the second endnode 304 does not issue an acknowledgement to the first endnode 302. Meanwhile, the second endnode 304 continues to acknowledge any transactions from the first endnode 302 that are received over the primary path 320 (operation 606). Thus, as long as no transactions from the first endnode 302 are received by the second endnode 304 over the primary path 320, the second endnode 304 does not return any acknowledgements back to the first endnode 302.

As long as the first endnode 302 is not receiving acknowledgements for outstanding transactions issued to the second endnode 304 over the primary path 320, the first endnode 302 continues to issue future transactions over both the primary path 320 and the alternate path 330 (operation 510). However, once acknowledgements from the second endnode 304 to the first endnode 302 resume (decision 512), the first endnode 302 recognizes that the primary path 320 is operational, since acknowledgements are returned by the second endnode 304 for transactions received by way of the primary path 320. At this point, the first endnode 302 may revert back, or “fail back,” to employing the primary path 320 as the sole path for communication between the first endnode 302 and the second endnode 304 (operation 514). In addition, as a result of subsequently receiving transactions solely over the primary path 320 from the first endnode 302, the second endnode 304 may also recognize that the first endnode 302, having thus received acknowledgements during failover, has failed back to the primary path 320.

In one implementation, the second endnode 304 may assume that the primary path 320 is defective in both directions while in failover mode, so that any transactions initiated by the second endnode 304 destined for the first endnode 302 should be transferred over the alternate path 330. In other embodiments, the second endnode 304 may employ the primary path 320 for outgoing communication with the first endnode 302 until it detects, by way of lack of acknowledgements from the first endnode 302, that the primary path 320 has failed. In yet another example, the primary path 320 for transactions directed from the first endnode 302 to the second endnode 304 may be different from a primary path utilized for transactions sent from the second endnode 304 to the first endnode 302.

In the case the second endnode 304 receives the same transactions over both the primary path 320 and the alternate path 330 during failover (decision 608), the second endnode 304 ignores data included in transactions that have already been received from the first endnode 302 to prevent multiple copies of the same transaction from being consumed by the second endnode 304 (operation 610). For example, if the second endnode 304 receives a transaction on the primary path 320 that was previously received over the alternate path 330, an acknowledgement is returned to the first endnode 302, and the transaction is ignored. On the other hand, if the second endnode 304 receives a copy of the transaction over the alternate path 330 that was previously received over the primary path 320, the latter received copy is ignored without an acknowledgement being returned, as the second endnode 304 previously acknowledged the earlier-arriving transaction received via the primary path 330.

In one embodiment, each transaction includes a source identifier and a destination identifier so that the sending and receiving parties for each transaction may be readily identified for proper routing through the interconnection fabric 301.

Also, an implied transaction identifier may be associated with each transaction for the purpose of allowing the second (receiving) endnode 304 to determine the order in which the transactions were sent by the first endnode 302. In many cases, the transaction identifier is used by the two endnodes 302, 304 to maintain synchronization with each other regarding the order of the transactions as they are transferred over the interconnection fabric 301. Typically, the transaction identifier is a counter value produced concurrently by both the first endnode 302 and the second endnode 304. Each endnode 302, 304 thus maintains a counter for each other endnode 302, 304 with which it communicates. In one example, the counter value is initialized to the same value in both the first endnode 302 and the second endnode 304. As the first endnode 302 issues each transaction to the second endnode 304 over the primary path 320, the first endnode 302 increments the associated counter value upon transfer of the transaction to maintain a running transaction identifier value. Similarly, the second endnode 304 increments its counter value associated with first endnode 302 each time a transaction has been received over the primary path 320 from the first endnode 302. Allowing the transaction identifier to remain implied in this manner during the majority of transactions transferred through the fabric 301 enhances the overall throughput of the fabric 301 by eliminating any unnecessary overhead involved with the transmission of the transaction identifier, as well as avoiding any processing delay in modifying the transaction to include the identifier.

In one particular implementation, to help the second endnode 304 distinguish between transactions received over the primary path 320 and those received over the alternate path 330, the TL block 352 of the first endnode 302 encapsulates each transaction issued over the alternate path 330 within a logical communication “envelope” that includes an explicit transaction identifier. Upon receipt of such a transaction, the second endnode 304 recognizes that an alternate path was utilized by the first endnode 302 by way of the existence of the envelope. Thus, the second endnode 304 may read the enclosed transaction identifier to determine whether that particular transaction was already received over the primary path 320 by comparing the explicit transaction identifier with its internal counter value associated with the implicit transaction identifiers for transactions received over the primary path 320. Therefore, the second endnode 304 may determine whether a received transaction is a duplicate, and thus should be consumed or ignored, by way of this comparison.

In another embodiment, the first endnode 302 may employ a second timeout value higher than the first timeout value described above to help discern between an actual failback condition and a false failback indication due to a reset or wraparound of the counter generating the transaction identifier. More specifically, the possibility exists that the first endnode 302 is in failover for a long enough period of time that the number of transactions issued during failover is more that the number of transactions identifiable by the transaction identifier due to a limited bit width for the identifier. Thus, any acknowledgements issued by the second endnode 304 at that point or thereafter cannot positively be associated with a single transaction, as two transactions with the same transaction identifier have been transferred by the first endnode 302 during that time (decision 512 of FIG. 5). As a result, the first endnode 302 may not be able to determine the specific transaction with which the received acknowledgement is identified. Given this scenario, the first endnode 302 may not be able to determine whether any unacknowledged transactions were previously issued, the lack of such acknowledgements indicating that no failure had actually occurred. Therefore, a second timeout value associated with a number of transactions representable by the transaction identifier may prevent any potential misinterpretation of an acknowledgement received by the first endnode 302 during failover by preventing any failback by the first endnode 302 after the second timeout has expired (operation 516). In an alternative embodiment, a maximum number of transactions issued during failover may be employed to similar effect (decision 512).

In an alternative embodiment, the computer system 300 may be configured to designate the alternate path 330 as a new primary path (also operation 516). In one example, the computer system 300 may take such action in the case failback does not occur after the second time period. Accordingly, the computer system 300 may denote the former primary path as exhibiting a hard failure, thus removing from service the first endnode 302 and the second endnode 304. Furthermore, the computer system 300 may present an indication of the hard failure to a computer operator or other person for the purpose of having the offending path repaired or replaced so that the full operational capability of the interconnection fabric 301 is restored.

When employing the failover/failback recovery mechanism described above, the computer system 300 possesses the capacity to employ an alternate communication path over the interconnection fabric 301, and then revert back to the primary path if the previous disruption of the primary path is alleviated. For example, a primary path through the fabric 303 may experience a stoppage in communication traffic as a result of a failure of a remote portion of the system 300. This stoppage may then cause a timer in a sending endnode to timeout due to a lack of corresponding acknowledgements over the affected primary path, thus forcing use of an alternate path. Once the source of the failure has been isolated, and acknowledgements once again are received by the sending endnode, the endnode may revert back to its primary path. Given this ability to recover the use of the primary path, the sending endnode may employ an aggressive (i.e., low) timeout value for the timer associated with transactions from the sending endnode to a receiving endnode to force failover to an alternate path more quickly to alleviate temporary problems with the primary path associated with failures of other portions of the computer system 300.

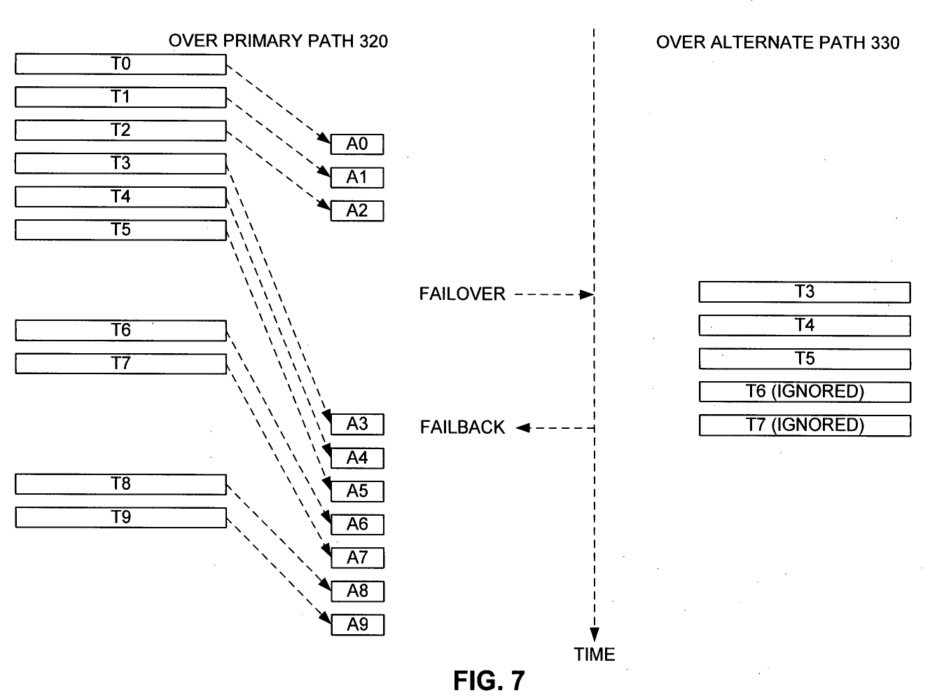

FIG. 7 provides a simplified flow diagram of one particular scenario in which the first (sending) endnode 302 fails over from the primary path 320 to the alternate path 330, and then fails back to the primary path 320. In this example, the first endnode 302 transfers three transactions, numbered T0, T1 and T2, to the second endnode 304, each of which the second endnode acknowledges by way of acknowledgements A0, A1 and A2. Subsequent transactions T3-T5 are then sent by the first endnode 302, after which time a first time period associated with T3 elapses, by which point no acknowledgement for that transaction has been received from the second endnode 304. As a result, the first endnode 302 fails over to the alternate path 330, resending transactions T3 through T5 over the alternate path 330, all of which are received by the second endnode 304. During this time, the first endnode 302 sends transactions T6 and T7 via both the primary path 320 and the alternate path 330. At some point thereafter, the second endnode 304, having received transactions T3-T7 over the primary path 320, issues acknowledgements A3-A7 to the first endnode 302 in response. Upon receipt of the acknowledgement A3, the first endnode 302 fails back to the primary path 320, issuing transactions T8 and T9. In response, the second endnode 304 returns acknowledgements A8 and A9. Further, since the second endnode 304 has received transaction T6 and T7 over the alternate path 330 as duplicate copies after those received over the primary path 320, the second endnode 304 ignores these duplicates.

In one embodiment, the methods heretofore described for managing communication within a computer system interconnection fabric, including formation of outgoing transactions and acknowledgements, handling of incoming transactions and acknowledgements, initiation of failover and failback, and other related functions, are performed by a transport layer (TL) block 352 of an endnode 302, 304, described earlier in conjunction with FIG. 4. In alternative embodiments, other logical structures not heretofore described may be employed to similar end. Further, these methods may be implemented in digital electronic hardware, software, or some combination thereof.

While several embodiments of the invention have been discussed herein, other embodiments encompassed by the scope of the invention are possible. For example, while some embodiments of the invention as described above are specifically employed within the environment of the computer system of FIG. 3, these embodiments are provided for the purpose of explaining embodiments of the invention within a working system. Thus, other computer system architectures employing varying interconnection fabric configurations may benefit from the various embodiments. For example, an endnode may be employed as an intermediary coupling between a sending endnode and a receiving endnode, possibly through one or more switches of the fabric. In this case, the intermediary endnode may employ embodiments of the invention to select either a primary or alternate path between itself and either the sending or receiving endnode, or both, for communications between the sending and receiving endnodes.

Also, while specific logic blocks of endnodes, such as crossbar switches, transport layer blocks, and link controller blocks, have been employed in the embodiments disclosed above, alternative embodiments utilizing other logic constructs are also possible. Further, aspects of one embodiment may be combined with those of alternative embodiments to create further implementations of the present invention. Thus, while the present invention has been described in the context of specific embodiments, such descriptions are provided for illustration and not limitation. Accordingly, the proper scope of the present invention is delimited only by the following claims.

What is claimed is:

1. A method for employing an interconnection fabric of a computer system having a first endnode and a second endnode, the method comprising:
transferring a first transaction from the first endnode toward the second endnode over a primary path of the fabric;
retransferring the first transaction from the first endnode toward the second endnode over an alternate path of the fabric after a period of time after transferring the first transaction;
transferring to the first endnode an acknowledgement of the first transaction received by the second endnode over the primary path after retransferring the first transaction; and
transferring a second transaction from the first endnode toward the second endnode solely over the primary path after the acknowledgement is received by the first endnode.

2. The method of claim 1, further comprising transferring a third transaction from the first endnode toward the second endnode over both the primary path and the alternate path after retransferring the first transaction, and before transferring the acknowledgement.

3. The method of claim 1, wherein the acknowledgement of the first transaction is transferred from the second endnode to the first endnode.

4. The method of claim 1, wherein the first and second transactions each comprise a destination identifier indicating the second endnode.

5. The method of claim 1, wherein the first and second transactions each have a transaction identifier associated therewith.

6. The method of claim 5, wherein a copy of the transaction identifier for each of the first and second transactions is generated at the first endnode from a counter within the first endnode.

7. The method of claim 5, wherein a copy of the transaction identifier for each of the first and second transactions is generated at the second endnode from a counter within the second endnode.

8. The method of claim 5, wherein a communication envelope comprises:
the first transaction retransferred over the alternate path toward the second endnode; and
the transaction identifier for the first transaction.

9. The method of claim 5, further comprising ignoring a duplicate of the first transaction received at the second endnode, wherein the identity of the first transaction is determined from the transaction identifier of the first transaction.

10. The method of claim 1, further comprising transferring the second transaction from the first endnode toward the second endnode over the alternate path in addition to the primary path after a second period of time has elapsed subsequent to the transfer of the first transaction.

11. The method of claim 1, further comprising transferring the second transaction from the first endnode toward the second endnode over the alternate path in addition to the primary path after a number of transactions subsequent to the first transaction have been transferred from the first endnode toward the second endnode.

12. The method of claim 1, further comprising designating the alternate path as a new primary path between the first endnode and the second endnode.

13. The method of claim 12, further comprising denoting the primary path as exhibiting a hard failure.

14. A digital storage medium comprising software instructions executable on a processor for employing the method of claim 1.

15. A computer system, comprising:
a first endnode;
a second endnode; and
an interconnection fabric coupling the first endnode and the second endnode;
wherein the first endnode is configured to:
transfer a first transaction toward the second endnode over a primary path of the fabric;
retransfer the first transaction toward the second endnode over an alternate path of the fabric after a period of time after the transfer of the first transaction; and
transfer a second transaction toward the second endnode solely over the primary path after an acknowledgement of the first transaction being received by the second endnode over the primary path is received by the first endnode.

16. The computer system of claim 15, wherein the second endnode is configured to transfer to the first endnode the acknowledgement of the first transaction received by the second endnode over the primary path.

17. The computer system of claim 15, wherein the first endnode is further configured to transfer a third transaction toward the second endnode over both the primary path and the alternate path after retransferring the first transaction, and before receiving the acknowledgement.

18. The computer system of claim 15, wherein the second endnode is further configured to ignore a duplicate of the first transaction.

19. The computer system of claim 15, wherein the first endnode is further configured to transfer the second transaction toward the second endnode over the alternate path in addition to the primary path after a second period of time has elapsed subsequent to the transfer of the first transaction.

20. The computer system of claim 15, wherein the first endnode is further configured to transfer the second transaction toward the second endnode over the alternate path in addition to the primary path after a number of transactions subsequent to the first transaction have been transferred toward the second endnode.

21. The computer system of claim 15, wherein the computer system is configured to designate the alternate path as a new primary path between the first endnode and the second endnode.

22. The computer system of claim 21, wherein the computer system is further configured to denote the primary path as exhibiting a hard failure.

23. The computer system of claim 15, wherein the interconnection fabric comprises:
a first switch;
a first communication link coupling the first switch with the first endnode;
a second communication link coupling the first switch with the second endnode;
a second switch;
a third communication link coupling the second switch with the first endnode; and
a fourth communication link coupling the second switch with the second endnode;
wherein the primary path comprises the first switch, the first communication link, and the second communication link; and
wherein the alternate path comprises the second switch, the third communication link, and the fourth communication link.

24. A computer system, comprising:
means for transferring a first communication transaction from a first endnode of the computer system toward a second endnode of the computer system over a primary path of an interconnection fabric of the computer system coupling the first endnode and the second endnode;
means for retransferring the communication transaction from the first endnode toward the second endnode over an alternate path of the fabric after a period of time after transferring the first transaction;
means for transferring to the first endnode an acknowledgement of the first transaction received by the second endnode over the primary path after retransferring the first transaction; and
means for transferring a second communication transaction from the first endnode toward the second endnode solely over the primary path after the acknowledgement is received by the first endnode.

25. The computer system of claim 26, further comprising means for transferring a third transaction from the first endnode toward the second endnode over both the primary path and the alternate path after retransferring the first transaction, and before transferring the acknowledgement.

26. The computer system of claim 26, wherein the acknowledgement of the first transaction is transferred from the second endnode to the first endnode.
